(19) United States
(12) Patent Application Publication
(10) Pub. No.: US 2020/0011448 A1
(43) Pub. Date: Jan. 9, 2020

(54) VALVE DEVICE AND SEMICONDUCTOR PRODUCTION DEVICE

(71) Applicant: FUJIKIN INCORPORATED, Osaka-shi, Osaka (JP)

(72) Inventors: Ryutaro TANNO, Osaka (JP); Yasumasa YANAGIDA, Osaka (JP); Tsutomu SHINOHARA, Osaka (JP)

(73) Assignee: FUJIKIN INCORPORATED, Osaka-shi, Osaka (JP)

(21) Appl. No.: 16/476,531

(22) PCT Filed: Nov. 2, 2017
(86) PCT No.: PCT/JP2017/039671

§ 371 Date: Sep. 24, 2019

(30) Foreign Application Priority Data
Dec. 12, 2016 (JP) 2016-240079

(51) Int. Cl. F16K 31/165; F16K 31/163

(52) U.S. Cl. CPC F16K 31/165; F16K 31/163

(57) ABSTRACT

A valve device and semiconductor production device that can be used long-term without seizing even during high-temperature use, and which do not have contaminants in the chambers thereof. The valve device includes: a boosting mechanism that amplifies drive force; a first and second stem receive force amplified by the boosting mechanism and move; and a diaphragm capable of opening and closing fluid passages. The boosting mechanism includes: a retainer and bearings; shafts having both ends thereof supported by the bearings; and arms pivotably supported by the shafts and having an outer end portion that receives drive force and an inner end portion that amplifies and transmits drive force to the first stem. In the retainer, bearings, shafts, and arms, the bearings and both ends of the shaft constitute a swinging portion in conjunction with the swinging by the arms, and thereamong, the bearings include a carbon fiber composite material.

### TECHNICAL FIELD

The present invention relates to a valve device and to a semiconductor production device including the valve.

### BACKGROUND ART

As a high-temperature resistant valve device, a valve device which includes a boosting mechanism that amplifies drive force by drive pressure (for example, compressed air) and which actuates a stem and a valve element via the boosting mechanism to open and close a fluid passage is proposed (for example, refer to PTL 1). The boosting mechanism is constituted by a supporting member, a shaft member supported by the supporting member, and a rotating member rotatably supported by the shaft member, and grease is normally applied between two members that slide against each other with a rotation of the rotating member among these members for the purpose of preventing seizing.

### CITATION LIST

### Patent Literature

[PTL 1]

Japanese Patent Application Publication No. H07-139648

### SUMMARY OF INVENTION

### Technical Problem

However, when the valve device is used over a long period of time at a high temperature, even when using high-temperature resistant grease, seizing or the like may occur due to depletion of the grease and the valve device may malfunction. In addition, an interior of a chamber may become contaminated with emitted gas from the grease.

In consideration thereof, an object of the present invention is to provide a valve device and a semiconductor production device which can be used over a long period of time without seizing even during high-temperature use, and which do not have contaminants in a chamber thereof.

### Solution to Problem

In order to solve the problem described above, a valve device according to one aspect of the present invention includes: a body in which a fluid passage is formed and which includes a valve seat; drive means which generates drive force; a boosting mechanism which amplifies the drive force; a valve element capable of opening and closing the fluid passage by coming into contact with and separating from the valve seat; and a stem provided so as to enable the valve element to come into contact with and separate from the body using received force having been amplified by the boosting mechanism, wherein the boosting mechanism includes: a supporting portion; a shaft portion having both ends thereof supported by the supporting portion; and a swinging portion which is swingably supported by the shaft portion and which has one end portion that receives the drive force and another end portion that amplifies and transmits the drive force to the stem, and a carbon material is used in at least a part of a sliding portion, in the swinging portion, the shaft portion, and the supporting portion, created by swinging of the swinging portion.

In addition, the carbon material may be a carbon fiber composite material.

In addition, a fiber direction of the carbon fiber composite material and a sliding direction of the sliding portion may coincide with each other.

In addition, a remaining portion other than the at least a part of the sliding portion in the swinging portion, the shaft portion, and the supporting portion may be made of stainless steel.

In addition, the supporting portion may have a bearing that rotatably supports the shaft portion, and the bearing may be made of a carbon material.

In addition, the sliding portion may be constituted by two members, and the two members may be in direct contact with each other.

A semiconductor production device according to one of the present invention includes: a chamber; and the valve device described above being arranged inside the chamber.

### Advantageous Effects of Invention

According to the present invention, a valve device and a semiconductor production device which can be used over a long period of time without seizing even during high-temperature use, and which do not have contaminants in a chamber thereof can be provided.

### BRIEF DESCRIPTION OF DRAWINGS

FIG. 1 is a vertical sectional view of a valve device in a closed state according to the present embodiment.

FIG. 2 is a perspective view showing a partial section of a boosting mechanism.

FIG. 3 shows a plan view of the boosting mechanism.

### DESCRIPTION OF EMBODIMENTS

A valve device according to an embodiment of the present invention will be described with reference to the drawings.

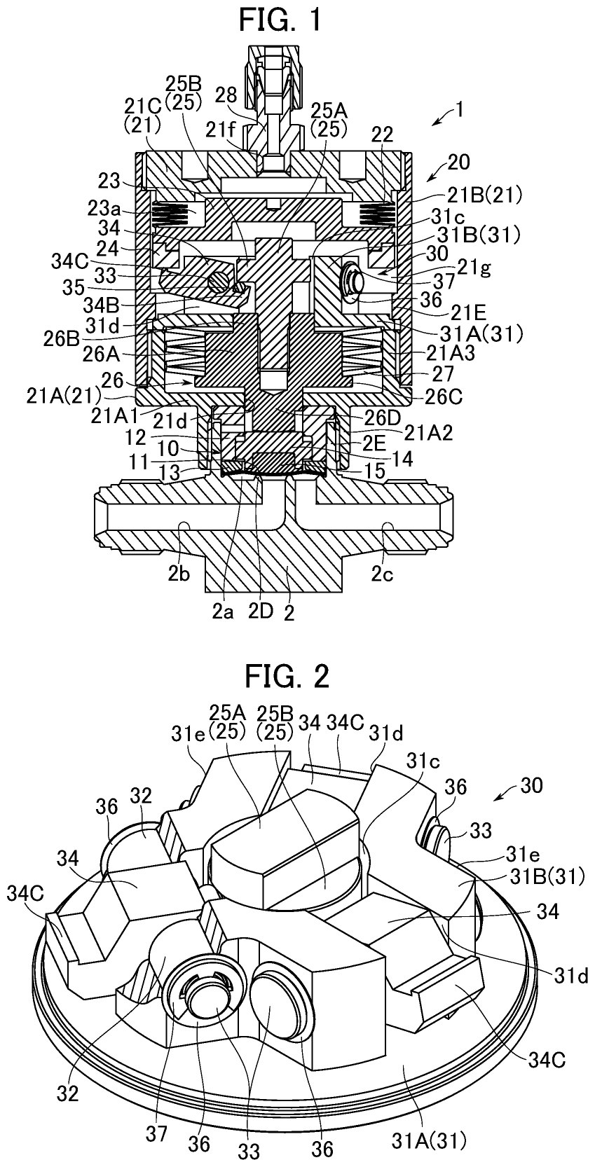

FIG. 1 is a vertical sectional view of a valve device 1 in a closed state according to the present embodiment. As shown in FIG. 1, the valve device 1 is a diaphragm valve device and is used inside, for example, a chamber of a semiconductor production device. The valve device 1 includes a body 2, a bonnet section 10, and an actuator section 20. In the following description, in the valve device 1, the actuator section 20 will be described as an upper side and a side of the body 2 will be described as a lower side. Moreover, unless specifically mentioned to the contrary, it is assumed that each member constituting the valve device 1 according to the present embodiment is made of stainless steel.

A valve chamber 2a and an inflow path 2b and an outflow path 2c which are communicated with the valve chamber 2a are formed in the body 2. An annular valve seat 2D which protrudes toward the bonnet section 10 is provided at a peripheral edge of a location where the inflow path 2b and the valve chamber 2a of the body 2 are communicated with each other (an opening portion of the inflow path 2b). In addition, the body 2 has a cylindrical portion 2E which is provided so as to extend upward, which has a cylindrical shape, and in which a male screw portion is formed in an outer circumferential portion thereof.

The bonnet section 10 has a diaphragm 11, a bonnet 12, a presser adapter 13, a disk 14, and a diaphragm presser 15.

The diaphragm 11 which is a valve element is made of, for example, a nickel-cobalt alloy and is constituted by a plurality of diaphragms, and an outer circumferential edge portion of the diaphragm 11 is clamped by the annular presser adapter 13 and held against the body 2. The diaphragm 11 which is a valve element has an approximately spherical shell shape, and a natural state of the diaphragm 11 is an upward-convex approximately arc shape. When the diaphragm 11 comes into contact with and separates from the valve seat 2D, communication or interruption takes place between the inflow path 2b and the outflow path 2c. When the valve device 1 is in a closed state, the diaphragm 11 comes into contact with the valve seat 2D and the inflow path 2b and the outflow path 2c are cut off from each other.

The bonnet 12 has an approximately cylindrical shape, and the bonnet 12 is inserted into the cylindrical portion 2E of the body 2 from above and is in contact with the presser adapter 13 from above.

The disk 14 and the diaphragm presser 15 are integrally configured and form an approximately columnar shape, inserted into the bonnet 12 and supported so as to be movable in a vertical direction, and capable of pressing a center portion of the diaphragm 11.

The actuator section 20 includes a casing 21, a bellows 22, a piston 23, a piston ring 24, a boosting mechanism 30, a first stem 25, a second stem 26, and a Belleville spring 27.

The casing 21 has a lower casing 21A, an intermediate casing 21B, and an upper casing 21C, and forms a housing chamber 21g for housing the boosting mechanism 30 and the like.

The lower casing 21A has a disk portion 21A1, a lower protruding portion 21A2, and an upper protruding portion 21A3. The disk portion 21A1 has a disk shape and a through-hole 21d is formed in a center portion thereof. The lower protruding portion 21A2 has a cylindrical shape and protrudes downward from a lower surface of the disk portion 21A1. A female screw portion is formed on an inner circumferential surface of the lower protruding portion 21A2 and the female screw portion is screwed to the male screw portion of the cylindrical portion 2E of the body 2. Accordingly, the bonnet 12 is pushed downward by the disk portion 21A1 and the presser adapter 13 presses the outer circumferential edge portion of the diaphragm 11. The upper protruding portion 21A3 has a cylindrical shape and protrudes upward from an upper surface of the disk portion 21A1. A male screw portion is formed on an outer circumferential surface of the upper protruding portion 21A3.

The intermediate casing 21B has a cylindrical shape and female screw portions are respectively formed on inner circumferential surfaces of an upper end portion and a lower end portion of the intermediate casing 21B. The female screw portion of the lower end portion is screwed to the male screw portion of the upper protruding portion 21A3 of the lower casing 21A to fix the intermediate casing 21B to the lower casing 21A. In addition, a protruding portion 21E which protrudes inward is provided on an inner circumferential surface of the intermediate casing 21B above the upper protruding portion 21A3.

The upper casing 21C has an approximately disk shape, a male screw portion is formed in an outer circumferential portion thereof, and a through-hole 21f is formed in a center portion thereof. The male screw portion is screwed to the female screw portion of the upper end portion of the intermediate casing 21B to fix the upper casing 21C to the intermediate casing 21B. A drive force introducing joint 28 is attached to the through-hole 21f. In the present embodiment, the drive force introducing joint 28 is attached to the upper casing 21C by welding.

The bellows 22 has a cylindrical shape as a whole, and an outer edge of an upper end portion thereof is fixed so as to come into close contact with a lower surface of the upper casing 21C. The bellows 22 is a so-called welding bellows and is created by alternately welding and joining together inner diameter portions and outer diameter portions of a plurality of annular metal plates.

The piston 23 has an approximately disk shape, and an outer edge of a lower end portion of the bellows 22 is fixed to an outer circumference of an upper surface of the piston 23 so as to come into close contact therewith. As described above, the upper casing 21C, the bellows 22, and the piston 23 are integrated and form a drive force introducing chamber 23a.

The piston ring 24 has an annular shape and is fixed to an outer circumferential portion of a lower surface of the piston 23.

Next, the boosting mechanism 30 will be described with reference to FIGS. 1 to 3.

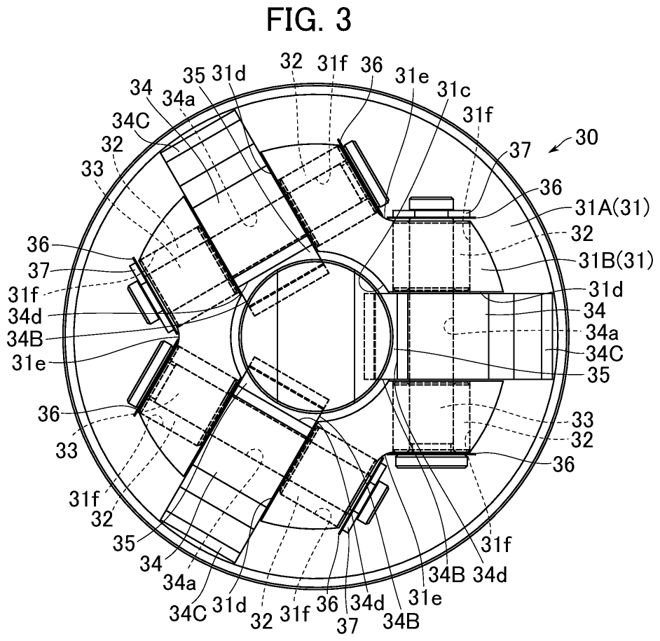

FIG. 2 is a perspective view showing a partial section of the boosting mechanism 30. FIG. 3 shows a plan view of the boosting mechanism 30.

The boosting mechanism 30 has a retainer 31, six bearings 32, three shafts 33, three arms 34, three parallel pins 35, six washers 36, and three retaining rings 37.

The retainer 31 has a disk-shaped bottom portion 31A and a pin supporting portion 31B which protrudes upward from the bottom portion 31A. A stem hole 31c which penetrates in the vertical direction is formed in the bottom portion 31A and the pin supporting portion 31B. An outer circumferential edge of the bottom portion 31A is sandwiched between the protruding portion 21E and the upper protruding portion 21A3 and, accordingly, the retainer 31 is fixed to the casing 21. Three groove portions 31d which extend in a radial direction are formed at regular intervals (120° intervals) in a circumferential direction in the pin supporting portion 31B. In addition, notches 31e are formed between the three groove portions 31d in an outer circumferential portion of the pin supporting portion 31B. Furthermore, bearing holes 31f are respectively formed at portions positioned so as to sandwich the groove portions 31d in the pin supporting portion 31B. One end of each bearing hole 31f opens to the groove portion 31d and another end opens to the notch 31e.

Each bearing 32 is made of a carbon fiber composite material (C/C composite) and has a cylindrical shape. A fiber direction off the carbon fiber composite material constituting the bearing 32 is configured in a same direction as a circumferential direction (corresponding to a sliding direction) of the bearing 32. In addition, the bearing 32 is inserted into the bearing hole 31f. The retainer 31 and the bearing 32 constitute a supporting portion.

Each shaft 33 that is a shaft portion penetrates a pair of bearings 32 positioned so as to sandwich the groove portion 31d.

In each arm 34 that is a swinging portion, a pin hole 34a is formed which penetrates the arm 34 in a direction orthogonal to a longitudinal direction of the arm 34. Each arm 34 is arranged in the groove portion 31d, and the shaft 33 is passed through the pin hole 34a to swingably support the arm 34. Each shaft 33 is inserted with force into the pin hole 34a of the arm 34, and the shaft 33 is configured so as to also rotate with swinging of the arm 34. Each arm 34 has an inner end portion 34B and an outer end portion 34C in a radial direction of the shaft 33, and a pin groove 34d is formed in the inner end portion 34B. The inner end portion 34B is positioned below a flange portion 25B (to be described later) of the first stem in the stem hole 31c, and the outer end portion 34C is positioned below the piston ring 24 and is capable of coming into contact with a lower surface of the piston ring 24.

Each parallel pin 35 is fitted into the pin groove 34d of the arm 34. The parallel pin 35 is capable of coming into contact with a lower surface of the flange portion 25B (to be described later) of the first stem 25. A central axis of each shaft 33 is configured to be positioned more to a side of the inner end portion 34B than a center position between a contact portion of the outer end portion 34C with respect to the piston ring 24 and a contact portion of the parallel pin 35 with respect to the flange portion 25B.

In this manner, since the central axis of the shaft 33 is positioned more to the side of the inner end portion 34B than the outer end portion 34C, force acting on the outer end portion 34C is amplified in the inner end portion 34B and amplified force acts on the first stem 25. An approximate amplification factor is expressed as (distance from central axis of shaft 33 to contact portion of outer end portion 34C of arm 34 with respect to piston ring 24)/(distance from central axis of shaft 33 to contact portion of parallel pin 35 with respect to flange portion 25B).

Each washer 36 is provided at both ends of each shaft 33. Each retaining ring 37 is provided at one end of each shaft 33 and prevents the shaft 33 from disengaging from the retainer 31.

As shown in FIG. 1, the first stem 25 includes a main body portion 25A which extends in a vertical direction and the flange portion 25B which protrudes outward from the main body portion 25A. A male screw portion is formed in a lower end portion of the main body portion 25A. The flange portion 25B is inserted into the stem hole 31c of the retainer 31, and the first stem 25 is movable in a vertical direction in the stem hole 31c. The flange portion 25B is positioned above the inner end portions 34B of the three arms 34.

The second stem 26 has an approximately columnar shape and includes a base portion 26A, an upper end portion 26B, a flange portion 26C, and a lower end portion 26D. A female screw portion is formed in the base portion 26A and the upper end portion 26B, and the first stem 25 and the second stem 26 are integrated by screwing the male screw portion of the first stem 25 to the female screw portion of the base portion 26A and the upper end portion 26B. The upper end portion 26B is inserted into the stem hole 31c. The flange portion 26C protrudes outward from between the base portion 26A and the lower end portion 26D. The lower end portion 26D is inserted into the through-hole 21d of the lower casing 21A and comes into contact with the disk 14 from above. The second stem 26 is supported so as to be movable in a vertical direction by having the upper end portion 26B thereof inserted into the stem hole 31c and having the lower end portion 26D thereof inserted into the through-hole 21d. In this manner, the first stem 25 and the second stem 26 are configured so as to be capable of approaching and separating from the body 2.

The Belleville spring 27 is arranged in plurality between the bottom portion 31A of the retainer 31 and the flange portion 26C of the second stem 26, and constantly biases the first stem 25 and the second stem 26 downward.

When the valve device 1 is in a closed state as shown in FIG. 1, the first stem 25 and the second stem 26 are biased downward by the Belleville springs 27 and, as the second stem presses the disk 14 and the diaphragm presser 15, the diaphragm 11 is pressed and comes into contact with the valve seat 2D and communication between the inflow path 2b and the outflow path 2c is interrupted. In addition, the flange portion 25B of the first stem 25 presses the parallel pin 35 downward, and the outer end portion 34C of the arm 34 is positioned above the inner end portion 34B.

Introducing drive pressure into the drive force introducing chamber 23a via the drive force introducing joint 28 causes downward force to act on the piston 23. When the piston 23 moves downward, the outer end portion 34C of the arm 34 is pushed downward by the piston ring 24. The arm 34 swings around a shaft center of the shaft 33, and the inner end portion 34B of the arm 34 moves upward. When upward force of the inner end portion 34B (the parallel pin 35) of the arm 34 and force by which gas flowing through the inflow path 2b pushes the diaphragm 11 exceed biasing force of the Belleville springs 27, the first stem 25 and the second stem 26 move upward and force that pushes the disk 14 and the diaphragm presser 15 downward decreases. Accordingly, the diaphragm 11 is pushed upward by pressure of fluid and separates from the valve seat 2D to open the valve.

The swinging of the arm 34 causes the shaft 33 to rotate, and both end portions of each shaft 33 slides against the bearing 32. In the present embodiment, a sliding portion is constituted by both end portions of each shaft 33 and the bearing 32, and each shaft 33 and the bearing 32 are in direct contact with each other without a lubricant such as grease being used therebetween.

As described above, with the valve device 1 according to the present embodiment, a carbon material is used in a part of a sliding portion that is created by swinging of the arm 34 in the retainer 31 including the arm 34, the shaft 33, and the bearing 32. In other words, among both end portions of each shaft 33 and the bearing 32 constituting the sliding portion, the bearing 32 is made of a carbon fiber composite material. According to this configuration, since a carbon fiber composite material has high heat resistance, wear resistance, and slidability, even when the valve device 1 is used at a high temperature (for example, 300° C. or higher), the valve device 1 can be used over a long period of time without the occurrence of seizing or the like in the sliding portion and high durability can be realized. In addition, since grease that is a lubricant is not required in the sliding portion, even when used inside a chamber of a semiconductor production device, the inside of the chamber does not become contaminated.

In addition, since a fiber direction of the bearing 32 made of a carbon fiber composite material and a rotation direction of the shaft 33 (a circumferential direction of the bearing, a sliding direction) are configured to coincide with each other, slidability in the sliding portion can be improved.

Furthermore, in the boosting mechanism 30, since the retainer 31, the shaft 33, and the arm 34 which constitute a remaining portion other than the bearing 32 being a part of the sliding portion is made of stainless steel, strength of the boosting mechanism 30 can be secured while increasing the slidability of the sliding portion.

In addition, although thermal expansivity must be evaluated upon designing allowance when stainless steel is used in the sliding portion, since a carbon fiber composite material has lower thermal expansivity than stainless steel, allowance between the bearing 32 and the shaft 33 can be readily controlled.

Furthermore, with a semiconductor production device that uses the valve device 1 according to the present embodiment by arranging the valve device 1 inside a chamber, since grease is not used, contamination of the inside of the chamber due to emitted gas from grease can be prevented.

It should be noted that the present invention is not limited to the embodiment described above. Various additions, modifications, and the like of the present invention will occur to those skilled in the art without departing from the scope of the invention.

For example, while a carbon fiber composite material is used as a carbon material constituting the bearing 32 in the embodiment described above, graphite may be used instead. In addition, while the sliding portion is constituted by both end portions of each shaft 33 and the bearing 32, for example, the sliding portion may be constituted by the arm 34 and a center portion of the shaft 33 in contact with the arm 34 and at least a part thereof may be made of a carbon material. Both end portions of each shaft 33 may be made of a carbon material. Furthermore, the entire boosting mechanism 30 may be made of a carbon material.

In addition, the boosting mechanism 30 is not limited to the configuration of the embodiment described above and may adopt other configurations. While the drive means is configured to generate drive force by drive pressure, for example, the drive means may be configured to generate drive force using a solenoid. Furthermore, while each member constituting the valve device 1 is made of stainless steel, other materials may be used as long as the materials can be used at a high temperature (for example, 300° C. or higher). While three arms 34 are provided, the arm 34 may be provided in any number that is two or more, and the configuration of the retainer 31 and the number of shafts 33 may be changed in accordance with the number of arms 34.

### REFERENCE SIGNS LIST

1 Valve device
2 Body
2b Inflow path
2c Outflow path
2D Valve seat
11 Diaphragm
25 First stem
26 Second stem
30 Boosting mechanism
31 Retainer
21 Bearing
Shaft Pin
34 Arm

1. A valve device, comprising:
a body in which a fluid passage is formed and which includes a valve seat;
a drive part configured to generate drive force;
a boosting mechanism configured to amplify the drive force;
a valve element configured to be capable of opening and closing the fluid passage by coming into contact with and separating from the valve seat; and
a stem provided to enable the valve element to come into contact with and separate from the body using received force having been amplified by the boosting mechanism, wherein
the boosting mechanism includes:
a supporting portion;
a shaft portion having both ends thereof supported by the supporting portion; and
a swinging portion which is swingably supported by the shaft portion and which has one end portion that receives the drive force and another end portion that amplifies and transmits the drive force to the stem, and
a carbon material is used in at least a part of a sliding portion, in the swinging portion, the shaft portion, and the supporting portion, that slides by swinging of the swinging portion.

2. The valve device according to claim 1, wherein the carbon material is a carbon fiber composite material.

3. The valve device according to claim 2, wherein a fiber direction of the carbon fiber composite material and a sliding direction of the sliding portion coincide with each other.

4. The valve device according to claim 1, wherein a remaining portion other than the at least a part of the sliding portion in the swinging portion, the shaft portion, and the supporting portion is made of stainless steel.

5. The valve device according to claim 4, wherein
the supporting portion has a bearing that rotatably supports the shaft portion, and
the bearing is made of a carbon material.

6. The valve device according to claim 1, wherein the sliding portion is constituted by two members, and the two members are in direct contact with each other.

7. A semiconductor production device, comprising:
a chamber; and
the valve device according to claim 1 being arranged inside the chamber.
